(19) United States
(12) Patent Application Publication
(10) Pub. No.: US 2021/0135857 A1
(43) Pub. Date: May 6, 2021

(54) SYSTEM AND METHODS FOR DISTRIBUTED RUNTIME LOGGING AND TRANSACTION CONTROL FOR MULTI-ACCESS EDGE COMPUTING SERVICES

(71) Applicant: Verizon Patent and Licensing Inc., Arlington, VA (US)

(72) Inventors: Raghuram Parvataneni, Edison, NJ (US); Kirk Campbell, Long Valley, NJ (US); Anil K. Guntupalli, Irving, TX (US)

(21) Appl. No.: 16/674,230

(22) Filed: Nov. 5, 2019

(51) Int. Cl. H04L 9/08; G06Q 20/38; H04L 29/08; H04L 9/06

(52) U.S. Cl. CPC H04L 9/0825; G06Q 20/382; H04L 2209/38; H04L 67/104; H04L 9/0643; H04L 67/289

(57) ABSTRACT

Systems and methods provide a distributed runtime logging and transaction control service for federated edge and public cloud services. A network device in an application service layer network receives a request from a network function, logs a record of the request, and publishes the record of the request in a distributed ledger. The network device receives a validation decision for the request, wherein the validation decision is provided from a main transaction control system for the application service layer network. The network device initiates a positive response to the request by the first edge cluster when the validation decision indicates an approval of the request, and initiates a denial response to the request when the validation decision indicates a disapproval of the request.

### BACKGROUND

One enhancement made possible through new broadband cellular networks is the use of Multi-access Edge Computing (MEC) platforms (also referred to as Mobile Edge Computing platforms). The MEC platforms allow high network computing loads to be transferred onto edge servers. Depending on the location of the edge servers relative to the point of attachment (e.g., a wireless station for an end device), MEC platforms can provide various services and applications to end devices with minimal latency, reduced backhaul, etc. These services make possible numerous types of collaborative scenarios in which users and organizations can share resources and information residing on MEC platforms. However, such sharing can also raise security and privacy concerns.

### BRIEF DESCRIPTION OF THE DRAWINGS

FIG. 1 is a diagram illustrating an exemplary network environment in which a distributed runtime logging and transaction control service described herein may be implemented;

FIG. 2 is a diagram of exemplary network connections in a portion of the environment of FIG. 1;

FIG. 3 is a block diagram illustrating exemplary logical components of an instance of a distributed transaction control system of FIG. 2;

FIG. 4 is a block diagram illustrating exemplary logical components of an instance of a central transaction control system of FIG. 2;

FIG. 5 is a block diagram illustrating exemplary components of a device that may correspond to one of the devices of FIG. 1;

FIG. 6 is a diagrams illustrating exemplary communications for providing the distributed runtime logging and transaction control service in a portion of the network environment of FIG. 2; and

FIG. 7 is a flow diagram illustrating exemplary processes for providing a distributed runtime logging and transaction control service, according to an implementation described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

One example of a collaborative use of MEC resources includes use of a federated MEC and public cloud services. Federated edge and cloud services may be created dynamically to achieve an application goal, such as sharing computational resources, data, and/or services. In a network federation, vendors of multiple network devices may agree on standards defining, for example, communications among devices and/or minimum system requirements. Resource sharing, however, can be hindered by security and privacy concerns. Since there may be multiple parties that partner in a federation, parties must be cognizant of who is accessing their shared resources, for what purposes, and potential consequences for granting access. Conventional audit logging does not resolve such concerns when multiple parties are involved and there is a trust factor among the parties. Conventional audit logs are also vulnerable to attacks that may compromise the integrity of such logging systems. The highly distributed nature of MEC locations makes it especially difficult to manage and control all the different platforms.

Systems and methods described herein provide a distributed runtime logging and transaction control service for federated MEC platforms. The service includes a set of distributed components that receive, exchange, and process transaction records with shared platforms. Such transactions may include, for example, data requests, service instantiations, domain name system (DNS) queries, etc., and their corresponding responses. The system enables runtime monitoring of federated control policies by including distributed logging functions which identify various transaction activities and intercept the transaction requests. The distributed runtime logging and transaction control service operates based on, for example, a smart contract blockchain to store logs and perform monitoring checks on the logs.

A blockchain is a decentralized (or distributed) ledger that is used to record transactions across multiple devices. Each record that is recorded contains a cryptographic hash of the previous record, a timestamp, and transaction data. The record cannot be altered retroactively without the alteration of all subsequent records and the consensus of the network. Because the records are being validated constantly, it is practically impossible to alter the ledger. Therefore, blockchains are considered secure by design. Generally, a smart contract includes computer code, on top of the blockchain, that implements a set of rules. For example, a smart contract may include logic that allows distributed components for the distributed runtime logging and transaction control service to validate incoming requests from other network functions.

According to one embodiment, a network device in a MEC network receives a request from a network function, logs a record of the request, and publishes the record of the request in a distributed ledger. The network device receives a validation decision for the request, wherein the validation decision is provided from a central transaction control system for the application service layer network. The network device initiates a positive response to the request by the first edge cluster when the validation decision indicates an approval of the request, and initiates a denial response to the request when the validation decision indicates a disapproval of the request.

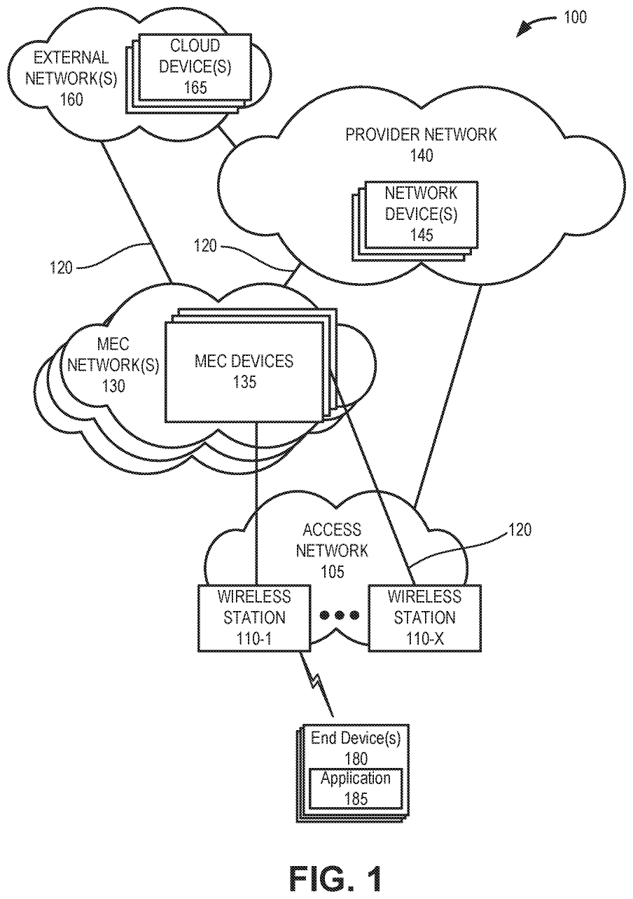

FIG. 1 illustrates an exemplary environment 100 in which an embodiment of the distributed runtime logging and transaction control service may be implemented. As illustrated, environment 100 includes an access network 105, one or more MEC networks 130, a provider network 140, and one or more external networks 160. Access network 105 may include wireless stations 110-1 through 110-X (referred to collectively as wireless stations 110 and generally as wireless station 110). MEC network 130 may include MEC devices 135; provider network 140 may include network devices 145; and external network 160 may include cloud devices 165. Environment 100 further includes one or more end devices 180.

The number, the type, and the arrangement of network device and the number of end devices 180 illustrated in FIG. 1 are exemplary. A network device, a network element, or a network function (referred to herein simply as a network device) may be implemented according to one or multiple network architectures, such as a client device, a server device, a peer device, a proxy device, a cloud device, a virtualized function, and/or another type of network architecture (e.g., Software Defined Networking (SDN), virtual, logical, network slicing, etc.). Additionally, a network device may be implemented according to various computing architectures, such as centralized, distributed, cloud (e.g., elastic, public, private, etc.), edge, fog, and/or another type of computing architecture.

Environment 100 includes communication links between the networks, between the network devices, and between end devices 180 and the network devices. Environment 100 may be implemented to include wired, optical, and/or wireless communication links 120 among the network devices and the networks illustrated. A connection via a communication link 120 may be direct or indirect. For example, an indirect connection may involve an intermediary device and/or an intermediary network not illustrated in FIG. 1. A direct connection may not involve an intermediary device and/or an intermediary network. The number and the arrangement of communication links 120 illustrated in environment 100 are exemplary.

Access network 105 may include one or multiple networks of one or multiple types and technologies. For example, access network 105 may include a Fifth Generation (5G) radio access network (RAN), Fourth Generation (4G) RAN, and/or another type of future generation RAN. Access network 105 may further include other types of wireless networks, such as a WiFi network, a Worldwide Interoperability for Microwave Access (WiMAX) network, a local area network (LAN), or another type of network that may provide an on-ramp to wireless stations 110, MEC network 130, and/or provider network 140.

Depending on the implementation, access network 105 may include one or multiple types of wireless stations 110. For example, wireless station 110 may include a next generation Node B (gNB), an evolved Node B (eNB), an evolved Long Term Evolution (eLTE) eNB, a radio network controller (RNC), a remote radio head (RRH), a baseband unit (BBU), a small cell node (e.g., a picocell device, a femtocell device, a microcell device, a home eNB, a repeater, etc.), or another type of wireless node. Wireless stations 110 may connect to MEC network 130 via backhaul links (e.g., links 120). According to various embodiments, access network 105 may be implemented according to various wireless technologies (e.g., radio access technology (RAT), etc.), wireless standards, wireless frequencies/bands, and so forth.

MEC network 130 may include an end device application or service layer network (also referred to as an “application service layer network”). According to an implementation, MEC network 130 includes a platform that provides application services at the edge of a network. MEC devices 135 may include variable compute configurations, including, without limitation, a CPU, GPU, FPGA, etc. MEC devices 135 may also include devices to perform orchestration and containerization functions. MEC devices 135 may be located to provide geographic proximity to various groups of wireless stations 110. Some MEC devices 135 may be co-located with network devices 145 of provider network 140.

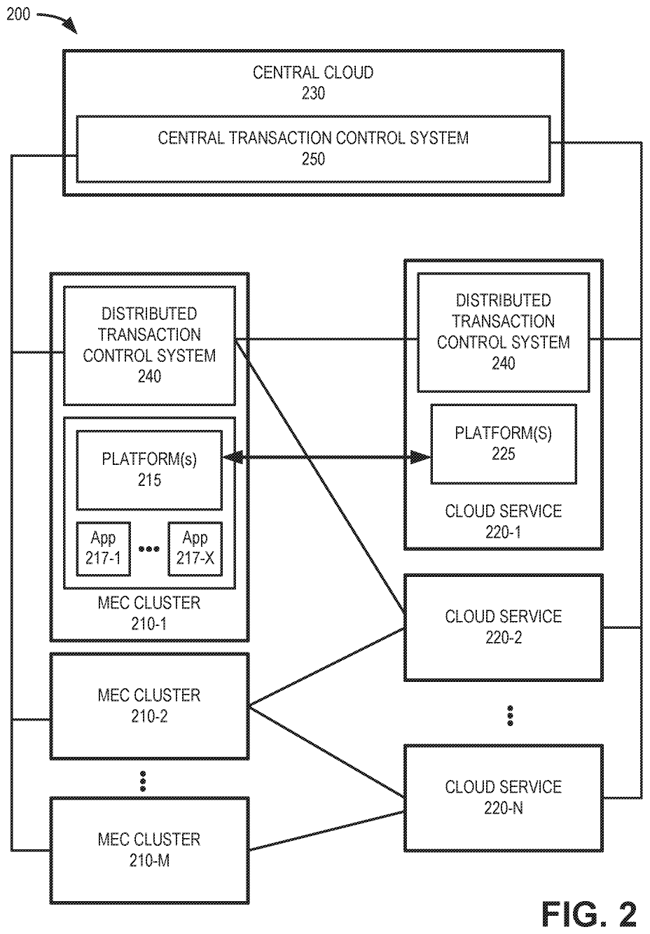

MEC network 130 may be implemented using one or multiple technologies including, for example, network function virtualization (NFV), software defined networking (SDN), cloud computing, or another type of network technology. Depending on the implementation, MEC network 130 may include, for example, virtualized network functions (VNFs), multi-access (MA) applications/services, and/or servers. MEC network 130 may also include other network devices that support its operation, such as, for example, a network function virtualization orchestrator (NFVO), a virtualized infrastructure manager (VIM), an operations support system (OSS), a local domain name server (DNS), a virtual network function manager (VNFM), and/or other types of network devices and/or network resources (e.g., storage devices, communication links, etc.). MEC network 130 is described further, for example, in connection with FIG. 2.

Provider network 140 may include one or multiple networks of one or multiple network types and technologies to support access network 105. For example, provider network 140 may be implemented to include a next generation core (NGC) network for a 5G network, an Evolved Packet Core (EPC) of an LTE network, an LTE-A network, an LTE-A Pro network, and/or a legacy core network. Depending on the implementation, provider network 140 may include various network devices 145, such as for example, a user plane function (UPF), an access and mobility management function (AMF), a session management function (SMF), a unified data management (UDM) device, an authentication server function (AUSF), a network slice selection function (NSSF), and so forth. According to other exemplary implementations, provider network 140 may include additional, different, and/or fewer network devices than those described.

External network 160 may include one or multiple networks. For example, external network 160 may be implemented to include a service or an application-layer network, the Internet, an Internet Protocol Multimedia Subsystem (IMS) network, a Rich Communication Service (RCS) network, a cloud network, a packet-switched network, or other type of network that hosts an end device application or service. Depending on the implementation, external network 160 may include various cloud devices 165 that provide various applications, services, or other type of end device assets, such as servers (e.g., web, application, cloud, etc.), mass storage devices, data center devices, and/or other types of network services pertaining to various network-related functions. According to an implementation, external network 160 may include a public cloud network that provides cloud services to applications 185 on end devices 180. Application providers may contract to use MEC network 130 to supplement/enhance application services from external network 160.

End device 180 includes a device that has computational and wireless communication capabilities. End device 180 may be implemented as a mobile device, a portable device, a stationary device, a device operated by a user, or a device not operated by a user. For example, end device 180 may be implemented as a Mobile Broadband device, a smartphone, a computer, a tablet, a netbook, a wearable device, a vehicle support system, a game system, a drone, or some other type of wireless device. According to various exemplary embodiments, end device 180 may be configured to execute various types of software (e.g., applications, programs, etc.). End device 180 may support one or multiple RATs (e.g., 4G, 5G, etc.), one or multiple frequency bands, network slicing, dual-connectivity, and so forth. Additionally, end device 180 may include one or multiple communication interfaces that provide one or multiple (e.g., simultaneous or non-simultaneous) connections via the same or different RATs, frequency bands, etc. As described further herein, end device 180 may download and/or register application 185. Application (or “app”) may be a customer application designed to use MEC compute resources from MEC network 130.

FIG. 2 is a diagram of exemplary network connections in a portion 200 of the network environment 100. As illustrated, network portion 200 may include MEC clusters 210-1 through 210-M (also referred to as MEC clusters 210, and individually or generally as MEC cluster 210), cloud service 220-1 through 220-N (also referred to as cloud services 220, and individually or generally as cloud service 220), and a central cloud 230.

MEC cluster 210 may correspond to a group of one or more MEC devices 135 located, for example, to provide low latency services for a particular geographic area. Each MEC cluster 210 may include a platform 215 that may include instances of applications (App) 217-1 through 217-X (also referred to as applications 217, and individually or generally as application 217), and a distributed transaction control system 240. MEC cluster 210 may support one or more platforms 215 and applications 217 that provide application services and/or microservices (e.g., a task, a function, etc.) for an application service. The application services may pertain to broadband services, higher user mobility (e.g., high speed train, remote computing, moving hot spots, etc.), Internet of Things (IoTs) (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services, drone delivery, public safety, etc.), broadcast-like services, and/or other types of mobile edge application services.

Cloud service 220 may correspond to group of one or more cloud devices 165 that provide cloud-based services. Cloud services 220 may host different platforms 225 for applications that may be executed, for example, on end devices 180. Different cloud services 220 may use different protocols and commands. Examples of cloud services 220 may include Amazon® Web Services (AWS), Microsoft Azure®, IBM IOT Bluemix®, etc. According to an implementation, platforms 225 on cloud services 220 may host different application services used by end devices 180. Application services may, for example, work in conjunction with application instances 217 to provide application services to end devices 180. According to an implementation described herein, platforms 225 may provide a request to one or more MEC clusters 210 via a respective platform 215. A request may include, for example, a data requests, a service instantiation request, a DNS query, or another type of transaction between cloud service 220 and MEC cluster 210.

Central cloud 230 may include a centralized component (e.g., network devices) or group of components serving MEC clusters 210 and cloud services 220. According to one implementation, central cloud 230 may be co-located with one or more network devices 145 in provider network 140. Central cloud 230 may include a central transaction control system 250 (also referred to as a main transaction control system). As described further below, central transaction control system 250 may interface with the distributed transaction control systems 240 of MEC clusters 210 and cloud services 220. For example, central transaction control system 250 may be a centralized component serving hundreds of edge locations (e.g., MEC clusters 210) and cloud services 220.

According to implementations described herein, different combinations of MEC clusters 210 and cloud services 220 may be joined in a federation that is managed by distributed transaction control systems 240 and governed by central transaction control system 250. Policies may be established among federation participants to define, for example, transaction policies (such as which MEC clusters 210 and cloud services 220 can conduct transactions with each other), system policies (such as what applications can interact with other applications in a MEC cluster), and access controls (e.g., public/private key structures). Transaction requests, which may include requests between platforms 215 and 225, inter-MEC requests, or intra-MEC requests, may require validation to ensure they comply with federation policies.

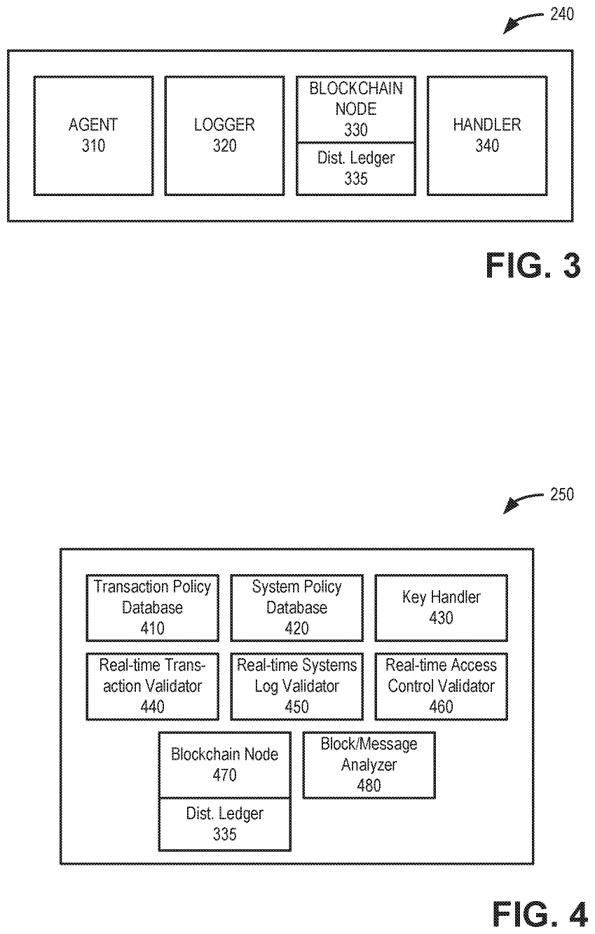

An instance of a distributed transaction control system 240 may permanently reside on each MEC cluster 210 and each cloud service 220. Distributed transaction control system 240 may work with distributed transaction control systems 240 in other MEC clusters 210 and/or cloud services 220, and with central transaction control system 250, to provide real-time logging and policy enforcement for MEC services. Distributed transaction control system 240 may receive, exchange, and process requests (e.g., access requests, data requests, service requests, etc.) from other federated components, such as other MEC clusters 210 and/or cloud services 220. According to one implementation, distributed transaction control system 240 may communicate with similar components in other MEC clusters 210, cloud services 220, and central cloud 230 to authenticate and/or validate that requests for MEC services are in accordance with stored policies. Distributed transaction control system 240 is described further in connection with, for example, FIG. 3, and central transaction control system 250 is described further in connection with, for example, FIG. 4.

FIG. 3 is a block diagram illustrating exemplary logical components of an instance of distributed transaction control system 240. As shown in FIG. 3, distributed transaction control system 240 may include an agent 310, a logger 320, a blockchain node 330, and a handler 340. Each of agent 310, logger 320, blockchain node 330, and handler 340 may be implemented as one or more MEC devices 135.

Agent 310 may identify, collect, and forward records (e.g., requests and responses) related to MEC services to logger 320. For example, agent 310 may flag transaction requests and transaction responses between different MEC clusters 210 and/or different cloud services 220, such as a request to initiate or instantiate an application. As another example, agent 310 may flag intra-MEC requests (e.g., system requests), such as communications related to and/or between applications or services within a MEC instance 210.

Logger 320 may receive records from agent 310 and write information to blockchain node 330. For example, logger 320 may encrypt and decrypt data being written to the blockchain. According to another implementation, logger 320 may generate blocks for publication by blockchain node 330. According to another implementation, logger 320 may generate smart contracts to be used in the blockchain.

Blockchain node 330 may receive records from logger 320. Blockchain node 330 may interact with other blockchain nodes 330 to form a distributed consensus network. Each participating blockchain node 330 in the distributed consensus network maintains a continuously-growing list of records referred to herein as a “distributed ledger” (e.g., distributed ledger 335) which may be associated with MEC-related transactions between participants (e.g., MEC clusters 210, cloud services 220, etc.) and which is secured from tampering and revision. Any validated updates from a trusted blockchain node 330 will be added into distributed ledger 335. Each version of the distributed ledger 335 contains a timestamp and a link to a previous version of the distributed ledger. Updates are added in chronological order to the distributed ledger 335, and the distributed ledger 335 is presented to each of participating blockchain nodes 330 in the distributed consensus network as a cryptographically secured block.

According to an implementation, each piece of data in the distributed ledger 335 may be considered as a hash value (i.e., unique signature of the original data) in a hash tree structure for efficiency. This hash tree ensures that blocks received from the trusted node are received undamaged and unaltered, and enables the distributed consensus network to check that the other blockchain nodes 330 in the distributed consensus network do not have fraudulent or inaccurate blocks in the distributed ledger 335. The distributed consensus network may be implemented using one or more blockchain frameworks, such as Hyperledger Fabric. According to an implementation, different sub-groups of blockchain nodes 330 may form a distributed consensus network for a federation. For example, only two or three blockchain nodes 330 (e.g., of MEC clusters 210 in close proximity to an originating blockchain node 330) may be used to validate updates to the distributed ledger 335.

Handler 340 may be responsible for executing or denying transactions. For example, handler 340 may initiate a service instantiation or provide data in response to a valid request from a cloud service 220. According to an implementation, handler 340 may apply a smart contract in the blockchain (e.g., distributed ledger 335) to determine if a request is valid before responding to the request. Handler 340 may use the smart contract to apply policies from central transaction control system 250 to parameters of particular requests. If policies have been previously stored/encountered in the blockchain, the smart contract may determine if a claim is approved or not approved. Unresolved claims (e.g., requests that are not addressed by the smart contract) may be resolved by central transaction control system 250. Handler 340 may then receive input from central transaction control system 250 that indicates whether a particular request is valid (e.g., in accordance with policies in transaction policy database 410 and systems policy database 420). Validation decisions from central transaction control system 250 may be stored in the blockchain ledger 335 and applied by handler 340 to future requests.

FIG. 4 is a block diagram illustrating exemplary logical components of central transaction control system 250. As shown in FIG. 4, central transaction control system 250 may include a transaction policy database 410, a system policy database 420, a key handler 430, a real-time transaction validator 440, a real-time systems log validator 450, a real-time access control validator 460, a blockchain node 470, and a block/message analyzer 480. Each of transaction policy database 410, system policy database 420, key handler 430, real-time transaction validator 440, real-time systems log validator 450, real-time access control validator 460, blockchain node 470, and block/message analyzer 480 may be implemented as one or more MEC devices 135, network devices 145, or cloud devices 160.

Transaction policy database 410 may store transaction policies for a cloud service 220 (e.g., an application being executed on cloud service 220) or MEC cluster 210. More specifically, transaction policy database 410 may include policies governing requests from external devices and functions (e.g., devices and functions outside of a MEC cluster 210), such as requests from network devices in a federation. Transaction policies may define, for example, whether an application is permitted to be instantiated on MEC clusters 210, which cloud services 220 can interact with which MEC clusters 210, etc. Policies in transaction policy database 410 may be configured, for example, by system administrators as part of a subscription/registration process for MEC services. Policies in transaction policy database 410 may be used, for example, to form smart contracts for the blockchain used by distributed transaction control system 240.

System policy database 420 may store system policies for installed/registered applications. More specifically, system policy database 420 may include policies governing requests from devices and functions internal to MEC cluster 210. For example, system policies may define the number of application instances that be may be instantiated on a MEC cluster 210, whether or not an application is permitted to interact with other applications, etc. Policies in system policy database 420 may be configured, for example, by system administrators as part of a subscription/registration process for MEC services. Policies in system policy database 420 may be used, for example, to form smart contracts for the blockchain used by distributed transaction control system 240.

Key handler 430 may manage cryptographic keys for the blockchain used with distributed transaction control system 240. Key handler 430 may implement aspects of security algorithms, including but not limited to, algorithm selection amongst a set of cipher suites, its associated key management and distribution, and its subsequent invocation for encryption, obfuscation, anonymization, signature generation, or any other security-related operations in the process of a blockchain-based service. Additionally, key handler 430 may register and distribute public keys and identifier (ID) pairings. For example, key handler 430 may manage public/private key pairs for communications between cloud service 220 and MEC clusters 210 for a particular application.

Real-time transaction validator 440 may retrieve records from blockchain node 470 and/or block/message analyzer and may validate the logged transactions based on the policies in transaction policy database 410. If real-time transaction validator 440 successfully validates a new transaction record, real-time transaction validator 440 may send an approval message to the distributed transaction control system 240 at the originating MEC cluster 210. If real-time transaction validator 440 fails to successfully validate a transaction request, real-time transaction validator 440 may send a disapproval message to the distributed transaction control system 240.

Real-time systems log validator 450 may retrieve records from blockchain node 470 and/or block/message analyzer 480 and may validate the logged transactions based on the policies in system policy database 420. If real-time systems log validator 450 successfully validates a new transaction record, real-time systems log validator 450 may send an approval message to the distributed transaction control system 240 at the originating MEC cluster 210. If real-time systems log validator 450 fails to successfully validate a transaction request, real-time systems log validator 450 may send a disapproval message to distributed transaction control system 240.

Real-time access control validator 460 may retrieve records from blockchain node 470 and/or block/message analyzer and may validate an access request based on assignments in key handler 430. If real-time access control validator 460 successfully validates an access request record, real-time access control validator 460 may send an approval message to the distributed transaction control system 240 at the originating MEC cluster 210. If real-time access control validator 460 fails to successfully validate an access request, real-time access control validator 460 may send a disapproval message to the distributed transaction control system 240.

Blockchain node 470 may act similar to blockchain node 330, receiving and storing a copy of distributed ledger 335. According to one implementation, blockchain node 470 may be included in every node combination for a distributed consensus network.

According to an implementation, block/message analyzer 480 may receive messages (e.g., alert messages) from distributed transaction control systems 240 to identify when validation decisions are needed. The alert message may, for example, identify a transaction request record in the distributed ledger that needs to be validated. Block/message analyzer 480 may determine if an alert message is related to a transaction policy, a system policy, or an access key and direct the record to the corresponding validator (e.g., one of real-time transaction validator 440, real-time systems log validator 450, or real-time access control validator 460). According to another implementation, block/message analyzer 480 may detect, from the distributed ledger 335 publication, that a transaction request is not covered by a smart contract in the ledger and is, therefore, not able to be validated by a handler 340 in distributed transaction control system 240. Block/message analyzer 480 may determine if a transaction request record (e.g., a block) is related to a transaction policy, a system policy, or an access key and direct the record to the corresponding validator (e.g., one of real-time transaction validator 440, real-time systems log validator 450, or real-time access control validator 460).

Although FIGS. 3 and 4 show exemplary logical components of distributed transaction control system 240 and central transaction control system 250, in other implementations, these systems may include fewer components, different components, or additional components than depicted in FIGS. 3 and 4. Additionally or alternatively, one or more components of distributed transaction control system 240 and central transaction control system 250 may perform functions described as being performed by one or more other components.

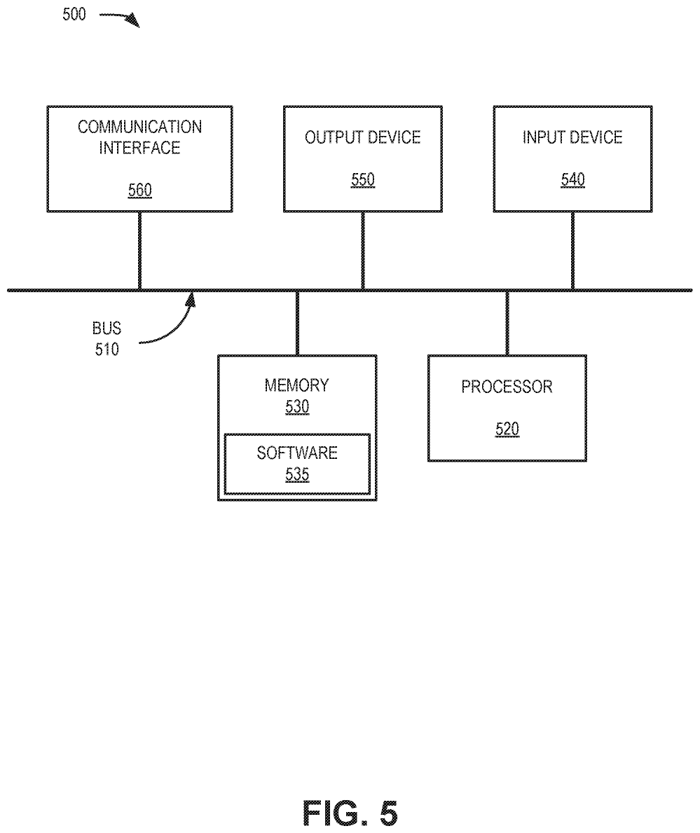

FIG. 5 is a block diagram illustrating exemplary components of a device that may correspond to one of the devices and functions of FIGS. 1-4. Each of MEC device 135, network device 145, cloud device 165, end device 180, MEC cluster 210, cloud service 220, and central transaction control system 250 may be implemented as a combination of hardware and software on one or more of devices 500. As shown in FIG. 5, device 500 may include a bus 510, a processor 520, a memory 530, an input device 540, an output device 550, and a communication interface 560.

Bus 510 may include a path that permits communication among the components of device 500. Processor 520 may include a processor, a microprocessor, an application specific integrated circuit (ASIC), a field programmable gate array (FPGA), programmable logic device, chipset, application specific instruction-set processor (ASIP), system-on-chip (SoC), central processing unit (CPU) (e.g., one or multiple cores), graphical processing unit (GPU), microcontrollers, and/or other processing logic (e.g., embedded devices) capable of controlling device 500 and/or executing programs/instructions. Memory 530 may include any type of dynamic storage device that may store information and instructions, for execution by processor 520, and/or any type of non-volatile storage device that may store information for use by processor 520.

Software 535 includes an application or a program that provides a function and/or a process. Software 535 is also intended to include firmware, middleware, microcode, hardware description language (HDL), and/or other form of instruction. By way of example, when device 500 is an end device 180, software 535 may include an application 185 that uses MEC services.

Input device 540 may include a mechanism that permits a user to input information to device 500, such as a keyboard, a keypad, a button, a switch, touch screen, etc. Output device 550 may include a mechanism that outputs information to the user, such as a display, a speaker, one or more light emitting diodes (LEDs), etc.

Communication interface 560 may include a transceiver that enables device 500 to communicate with other devices and/or systems via wireless communications, wired communications, or a combination of wireless and wired communications. For example, communication interface 560 may include mechanisms for communicating with another device or system via a network. Communication interface 560 may include an antenna assembly for transmission and/or reception of radio frequency (RF) signals. For example, communication interface 560 may include one or more antennas to transmit and/or receive RF signals over the air. In one implementation, for example, communication interface 560 may communicate with a network and/or devices connected to a network. Alternatively or additionally, communication interface 560 may be a logical component that includes input and output ports, input and output systems, and/or other input and output components that facilitate the transmission of data to other devices.

Device 500 may perform certain operations in response to processor 520 executing software instructions (e.g., software 535) contained in a computer-readable medium, such as memory 530. A computer-readable medium may be defined as a non-transitory memory device. A non-transitory memory device may include memory space within a single physical memory device or spread across multiple physical memory devices. The software instructions may be read into memory 530 from another computer-readable medium or from another device. The software instructions contained in memory 530 may cause processor 520 to perform processes described herein. Alternatively, hardwired circuitry may be used in place of or in combination with software instructions to implement processes described herein. Thus, implementations described herein are not limited to any specific combination of hardware circuitry and software.

Device 500 may include fewer components, additional components, different components, and/or differently arranged components than those illustrated in FIG. 5. As an example, in some implementations, a display may not be included in device 500. As another example, device 500 may include one or more switch fabrics instead of, or in addition to, bus 510. Additionally, or alternatively, one or more components of device 500 may perform one or more tasks described as being performed by one or more other components of device 500.

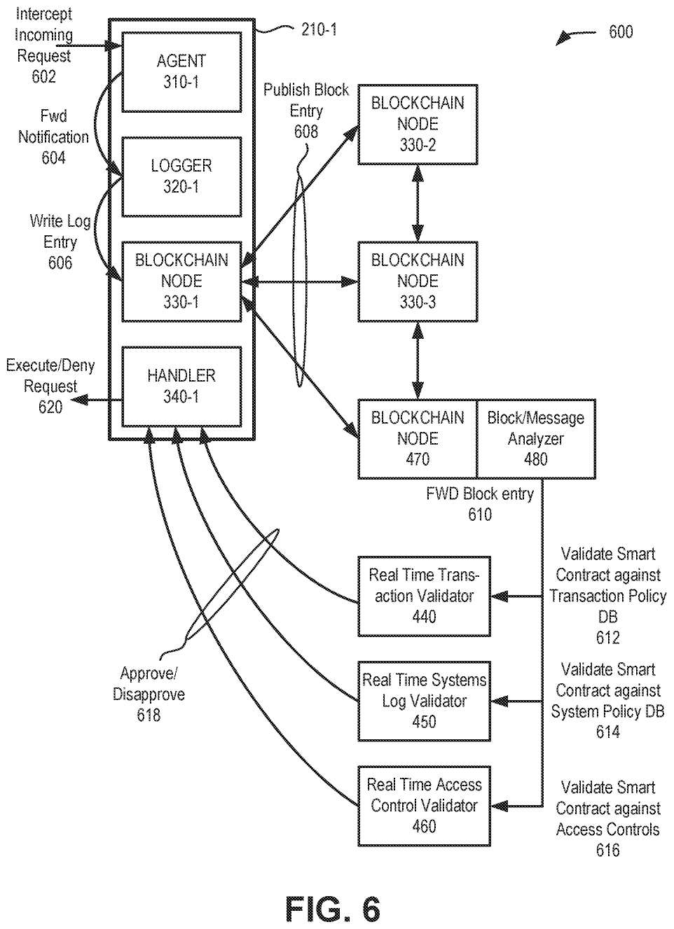

FIG. 6 is a diagram illustrating exemplary communications for providing the distributed runtime logging and transaction control service in a portion 600 of network environment 100. More particularly, communications in FIG. 6 represent communications to validate a transaction request when a policy is not currently part of a smart contact. Network portion 600 may include a distributed transaction control systems 240 of MEC cluster 210-1, including agent 310-1, logger 320-1, blockchain node 330-1, and handler 340-1. Network portion 600 may also include blockchain nodes 330-2 (e.g., in MEC cluster 210-2, not shown) and 330-3 (e.g., in MEC cluster 210-3, not shown). Network portion 600 may further include real-time transaction validator 440, real-time systems log validator 450, real-time access control validator 460, blockchain node 470, and block/message analyzer 480 each of which may be included, for example, in central transaction control system 250 (not shown). FIG. 6 provides simplified illustrations of communications in network portion 600 and is not intended to reflect every signal or communication exchanged between devices.

As shown in FIG. 6, an agent 310-1 of a MEC cluster 210-1 may detect and intercept an incoming request 602, such as a request for access, data, or services. For example, agent 310-1 may identify a request (e.g., a DNS request, a data request, etc.) from a cloud service 220 or another MEC cluster 210. Alternatively, agent 310-1 may identify an internal request from an application executing on MEC cluster 210-1. Before directing request 602 to a function (e.g., platform 225) that responds to the request, agent 310-1 may divert request 602 through distributed transaction control system 240. In another implementation, request 602 may also or alternatively include a response (e.g., generated by platform 225 in MEC cluster 210-1) to a request. Agent 310-1 may forward a notification 604 of the request to logger 320-1.

Logger 320-1 may receive notification 604 and may write a log entry 606 for the blockchain. The log entry may include, for example, application identifier (ID), a transaction type (e.g., DNS query, data request, instantiation request, etc.); a requestor ID (e.g., a MEC instance ID, cloud service ID, etc., of the function initiating the request), a target ID (e.g., a MEC instance ID, cloud service ID, etc., of the function receiving the request), a timestamp, and/or other information necessary to validate a request against policies in central transaction control system 250.

Blockchain node 330-1 may receive log entry 606 and publish a block entry 608 to the distributed consensus network (e.g., other blockchain nodes 330-2, 330-3, and 470) for confirmation and entry into a distributed ledger. Block/message analyzer 480 in central transaction control system 250 may receive block entry 608 and determine whether a validation decision is needed. For example, block/message analyzer 480 may detect from block entry 608 and the distributed ledger that the transaction request is not covered by a smart contract. Alternatively, the distributed transaction control system 240 (e.g., handler 340-1) in MEC cluster 210-1 may send an alert message (not shown) to central transaction control system 250 requesting resolution of the transaction request 602, when a resolution is not available via a smart contract. Assuming a transaction validation is needed from central transaction control system 250, block/message analyzer 480 may decrypt (if necessary) and forward block entry 608 as forwarded block entry 610 to one or more of real-time transaction validator 440, real-time systems log validator 450, and real-time access control validator 460.

Real-time transaction validator 440 may evaluate the transaction(s) included in forwarded block entry 610 against the policies in transaction policy database 410, as indicated by reference 612. For example, based on policies assigned to a particular cloud service 220 or application, real-time transaction validator 440 may determine whether the transaction in forwarded block entry 610 is approved (e.g., not in violation of a policy) or disapproved (e.g., violates a policy of transaction policy database 410).

Real-time systems log validator 450 may evaluate the transaction(s) included in forwarded block entry 610 against the policies in system policy database 420, as indicated by reference 614. For example, based on policies assigned to the particular cloud service 220 or application, real-time system log validator 450 may determine whether the transaction in forwarded block entry 610 is approved (e.g., not in violation of a policy) or disapproved (e.g., violates a policy of system policy database 420).

Real-time access control validator 460 may evaluate the transaction(s) included in forwarded block entry 610 against access controls in key handler 430, as indicated by reference 616. For example, based on access keys assigned to the particular cloud service 220 or application, real-time access control validator 460 may determine whether an access request record in forwarded block entry 610 is approved (e.g., uses correct access keys) or disapproved (e.g., does not have correct access keys).

Assuming each of real-time transaction validator 440, real-time systems validator 450, and real-time access control validator 460 successfully validate forwarded block entry 610, each of real-time transaction validator 440, real-time systems validator 450, and real-time access control validator 460 may send an approval message 618 to handler 340-1 at MEC instance 210-1. Conversely, if any of real-time transaction validator 440, real-time systems validator 450, or real-time access control validator 460 fail to successfully validate forwarded block entry 610, real-time transaction validator 440, real-time systems validator 450, or real-time access control validator 460 may send a disapproval message 618 to handler 340-1. According to an implementation, approve/disapprove message 618 may also include policy descriptions that can be published to the blockchain to enable handler 340 to resolve future identical/similar transaction requests.

Based on approve/disapprove message 618, handler 340-1 may respond to request 602 with instructions 620 to execute or deny the request. For example, an approved request may be forwarded to function, such as a DNS function, platform 225, or an orchestrator function, to provide a response. If one or more disapprovals are received by handler 340-1, handler 340-1 may provide instructions to deny or reject a corresponding request. Similar to the communications described above, a response (not shown in FIG. 6) based on instructions 620 may be detected/intercepted by agent 310-1 and forwarded to logger 320 for validation and publication to the distributed ledger.

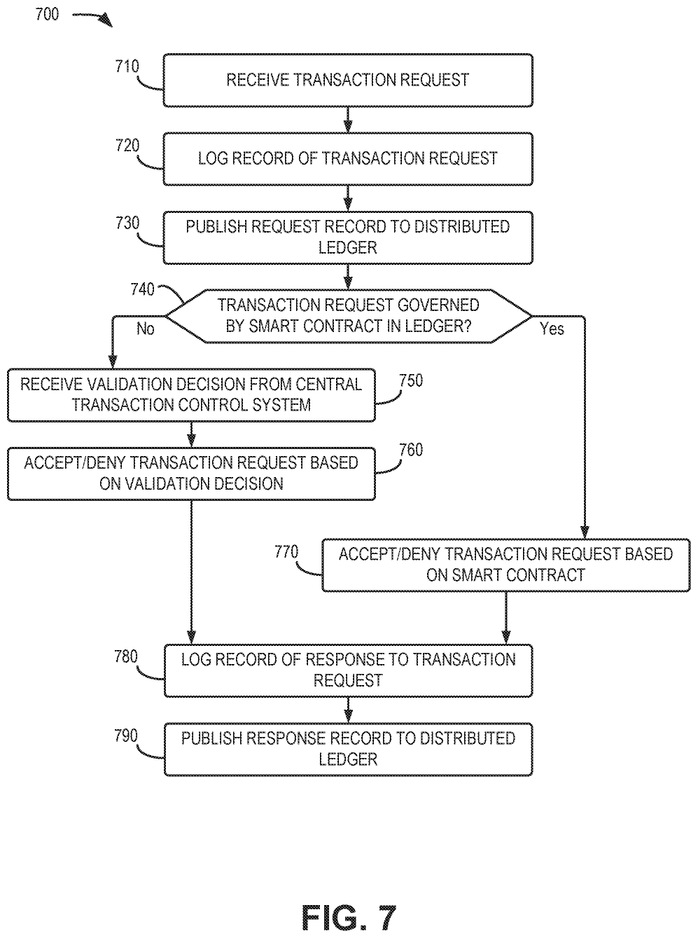

FIG. 7 is a flow diagram illustrating an exemplary process 700 for managing a MEC transaction request with a distributed runtime logging and transaction control service. In one implementation, process 700 may be performed by a MEC cluster 210. In another implementation, process 700 may be performed by MEC cluster 210 in conjunction with central transaction control system 250 or another network device in network environment 100.

Process 700 may include receiving a transaction request (block 710), logging a record of the transaction request (block 720), and publishing the request record to a distributed ledger (block 730). For example, a MEC cluster 210 may receive a transaction request, such as a DNS query, data request, or service instantiation request. The distributed transaction control system 240 (e.g., agent 310) in MEC cluster 210 may detect and intercept the request for validation prior to acting on the request. Distributed transaction control system 240 (e.g., logger 320) may generate a record of the transaction request and publish a request record as a block for the distributed ledger 335 of blockchain node 330. Distributed transaction control system 240 (e.g., blockchain node 330) may publish the block to other blockchain nodes 330 of the distributed consensus network to add to an immutable distributed ledger of transactions.

Process 700 may further include determining if the transaction request is governed by a smart contract in the distributed ledger (block 740). For example, distributed transaction control system 240 (e.g., handler 340) may compare the transaction request with smart contract data in the distributed ledger 335 to determine, for example, if a similar request has been validated against MEC transaction policies.

If the transaction request is not governed by a smart contract in the distributed ledger (block 740—No), process 700 may include receiving a validation decision from a central transaction control system (block 750), and accepting or denying the transaction request based on the validation decision (block 760). For example, if distributed transaction control system 240 (e.g., handler 340) does not detect a similar decision for the transaction request in the distributed ledger, handler 340 may await and receive a transaction decision (e.g., approve/disapprove message 618) from central transaction control system 250. Central transaction control system 250 (e.g., block/message analyzer 480) may, for example, detect from the blockchain publication that a transaction request is not covered by a smart contract. Alternatively, distributed transaction control system 240 (e.g., handler 340) may send an alert message to central transaction control system 250 requesting resolution of the transaction request. Based on the transaction decision from central transaction control system 250 (e.g., from one of real-time transaction validator 440, real-time systems validator 450, or real-time access control validator 460), handler 340 may provide instructions (e.g., to platform 225) to execute a positive response or may deny the transaction request.

If the transaction request is governed by a smart contract in the distributed ledger (block 740—Yes), process 700 may include accepting or denying the transaction request based on the smart contract (block 770). For example, if distributed transaction control system 240 (e.g., handler 340) detects a decision/policy in the distributed ledger 335 that is applicable to the transaction request, handler 340 provide instructions (e.g., to platform 225) to execute a positive response or may deny the transaction request based on the previous logged activity.

After accepting or denying the transaction request (block 760 or block 770), process 700 may include logging a record of a response to the transaction request (block 780), and publishing the response record to a distributed ledger (block 790). For example, distributed transaction control system 240 (e.g., agent 310) may detect the response instructions. Distributed transaction control system 240 (e.g., logger 320) may generate a record of the transaction response and publish a response record as a block for the distributed ledger 335 of blockchain node 330. According to an implementation, the response record may include policy descriptions to enable the distributed transaction control system 240 to resolve future identical/similar transaction requests.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration, but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of signals and blocks have been described with regard to the processes illustrated in FIGS. 6-7, the order of the signals and/or blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 520, etc.), or a combination of hardware and software (e.g., software 535).

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 520) of a device. A non-transitory storage medium includes one or more of the storage mediums described in relation to memory 530.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known to those of ordinary skill in the art are expressly incorporated herein by reference and are intended to be encompassed by the claims.

What is claimed is:

1. A method, comprising:
receiving, by a distributed transaction control system in a first edge cluster of an application service layer network, a request from a network function;
logging, by the distributed transaction control system, a record of the request;
publishing, by the distributed transaction control system, the record of the request in a distributed ledger;
receiving, by the distributed transaction control system, a validation decision for the request, wherein the validation decision is provided from a main transaction control system for the application service layer network;
initiating, by the distributed transaction control system, a positive response to the request by the first edge cluster when the validation decision indicates an approval of the request; and
initiating, by the distributed transaction control system, a denial response to the request when the validation decision indicates a disapproval of the request.

2. The method of claim 1, wherein receiving the request further comprises receiving the request from a second edge cluster or a cloud service.

3. The method of claim 1, wherein the request includes one of a domain name system (DNS) query, a service instantiation request, or a data request.

4. The method of claim 1, further comprising:
storing, in a memory of the main transaction control system, control policies for the first edge cluster;
obtaining, by the main transaction control system, the request;
comparing, by the main transaction control system, the request against the control policies; and
sending, by the main transaction control system and based on the comparing, the validation decision to the distributed transaction control system.

5. The method of claim 4, wherein the control policies include one or more of:
transaction policies governing requests from devices and functions external to the first edge cluster;
system policies governing requests from devices and functions internal to the first edge cluster; or
access policies governing access requests to the first edge cluster.

6. The method of claim 1, further comprising:
storing, by the distributed transaction control system and in a local memory, the distributed ledger.

7. The method of claim 1, further comprising:
storing, by the main transaction control system, the distributed ledger.

8. The method of claim 1, wherein the validation decision includes policy information supporting the validation decision.

9. The method of claim 8, further comprising:
publishing another record of one of the positive response or the denial response in the distributed ledger, wherein the other record includes the policy information supporting the validation decision.

10. The method of claim 1, further comprising:
receiving, by the distributed transaction control system, another request from the network function;
logging, by the distributed transaction control system, another record of the request;
publishing, by the distributed transaction control system, the other record of the request in the distributed ledger; and
determining, by the distributed transaction control system, a validation decision for the other request based on a smart contract in the distributed ledger.

11. One or more network devices in an application service layer network, the one or more network devices comprising:
a communications interface;
a memory to store instructions; and
one or more processors, wherein the one or more processors execute the instructions to:
receive a request from a network function;
log a record of the request;
publish the record of the request in a distributed ledger;
receive a validation decision for the request, wherein the validation decision is provided from a main transaction control system for the application service layer network;
initiate a positive response to the request when the validation decision approves the request; and
initiate a denial response to the request when the validation decision disapproves the request.

12. The one or more network device of claim 11, wherein, when receiving the request, the one or more processors further execute the instructions to:
receive the request from a function within a first edge cluster.

13. The one or more network device of claim 11, wherein the request includes a request by one application instance to interact with another application.

14. The one or more network device of claim 11, wherein the one or more processors further execute the instructions to:
store, in the memory, the distributed ledger.

15. The one or more network device of claim 11, wherein the validation decision includes policy information supporting the validation decision.

16. The one or more network device of claim 15, wherein the one or more processors further execute the instructions to:
publish another record of one of the positive response or the denial response in the distributed ledger, wherein the other record includes the policy information supporting the validation decision.

17. The one or more network device of claim 11, wherein the one or more processors further execute the instructions to:
receive another request from the network function; and
determine a validation decision for the other request based on a smart contract in the distributed ledger.

18. A non-transitory computer-readable storage medium storing instructions executable by a processor of a device, which when executed cause the device to:
receive a request from a network function;
log a record of the request;
publish the record of the request in a distributed ledger;
receive a validation decision for the request, wherein the validation decision is provided from a main transaction control system for an application service layer network;
initiate a positive response to the request when the validation decision approves the request; and
initiate a denial response to the request when the validation decision disapproves the request.

19. The non-transitory computer-readable storage medium of claim 18, further comprising instructions to cause the device to:
publish another record of one of the positive response or the denial response in the distributed ledger, wherein the other record includes policy information supporting the validation decision.

20. The non-transitory computer-readable storage medium of claim 18, further comprising instructions to cause the device to:
receive another request from the network function;
publish another record of the request in the distributed ledger; and
determine a validation decision for the other request based on a smart contract in the distributed ledger.
